(19) United States
(12) Patent Application Publication
(10) Pub. No.: US 2016/0131565 A1
(43) Pub. Date: May 12, 2016

(54) METHOD OF DETERMINING A FILL LEVEL OF AN OSCILLATOR OF AN OSCILLATOR TUBE, AND OSCILLATOR TUBE

(71) Applicant: ANTON PAAR GMBH, GRAZ-STRASSGANG (AT)

(72) Inventor: ROBERT BREIDLER, GRAZ (AT)

(21) Appl. No.: 14/929,834

(22) Filed: Nov. 2, 2015

(30) Foreign Application Priority Data
Nov. 3, 2014 (AT) A50792/2014

(51) Int. Cl. G01N 9/00; G01F 23/22

(52) U.S. Cl. CPC G01N 9/002; G01F 23/22; G01N 2009/006

(57) ABSTRACT

A method determines a degree of filling of an oscillator tube of a frequency oscillator with a fluid to be examined, in particular related to the density measurement of fluids with the frequency oscillator. By adjustment or calibration standards for the fluid to be examined, or for fluids possessing various viscosities, the relationship between the damping and/or oscillation amplitude of the frequency oscillator and the degree of filling of the oscillator tube is determined. In the course of determining the degree of filling, a parameter relevant for the damping and/or oscillation amplitude of the frequency oscillator is measured, and the measured value is considered as relevant and functionally related to the degree of filling and can be used for evaluating or determining the degree of filling.

### CROSS-REFERENCE TO RELATED APPLICATION

This application claims the priority, under 35 U.S.C. §119, of Austrian application A50792/2014, filed Nov. 3, 2014; the prior application is herewith incorporated by reference in its entirety.

### BACKGROUND OF THE INVENTION

### Field of the Invention

The invention relates to a method for determining a degree of filling of an oscillator tube of a frequency oscillator with a fluid to be investigated, particularly with respect to the density measurement of fluids in the oscillator tube. Furthermore, the invention relates to an oscillator U-tube.

The measurement of the density of fluid media with a frequency oscillator is based on the fact that the oscillation of a hollow body filled with a sample to be examined, in particular wherein the mass or the volume is constant, is a function of the density of the filled medium.

An oscillator U-tube is formed from a hollow U-shaped glass or metal tube which is excited by an electronic oscillation, in particular at resonant oscillation. The two legs of the U-shaped tube form the spring elements of the oscillator U-tube. The natural frequency of the U-shaped tube is affected by that part of the sample that actually participates in the oscillation and is in the tube. The volume participating in the oscillation is limited by the quiescent oscillation nodes at the two clamping points of the tube. If the oscillator U-tube is filled entirely with the sample at least up to the clamping points, then the same precisely defined volume participates in the oscillation, and the mass of the sample may therefore be assumed to be proportional to its density. Overfilling of the vibrator beyond the clamping points is irrelevant for the measurement. For this reason, the density of media can be measured with the oscillator with the flow through the oscillator or the oscillator tube. However, problems arise when the oscillator tube is not entirely filled.

FIGS. 1 and 2 show the basic principle of a frequency oscillator according to the invention in the form of a double bend oscillator with mass balance, but any further damping elements inserted if necessary, are not shown here. The double bend oscillator 60 has 4 U-shaped oscillator tubes 9 whose ends or legs 10, 11 are connected to one end connection 2, 3. In order to perform a density measurement, the tube 9 has fluid flowing into it via the end connections or carriers 2, 3. In the bent sections 5, 5′, the longitudinal central region of the tube 9 has a base 4 bent or folded back in the direction of the end connections 2, 3 in order to form further legs 12, 13, as can be seen in FIG. 2. There is an oscillation exciter 7 in at least one of the bent sections 5, while there is a measuring unit 7′ in the respective opposite bent section 5′ for measuring at least one oscillation parameter, preferably the oscillation amplitude, which is used or taken into account for the excitation of an oscillation. Thus, in practice, one or two oscillation exciters 7 and one or two measuring units 7′ are provided. Upon the oscillation exciter 7 receiving a signal from the measuring unit 7′, the tube 9 and the bent sections 5, 5′ are oscillated, wherein the bent sections 5, 5′ swing towards and then away from one another as shown by the arrow 6. The oscillation parameter is picked up by a measuring unit 7′ in the form of an oscillation detector. The oscillation excitation and the oscillation pick-up are advantageously electromagnetically controlled and monitored by measuring or sensor electronics 40, or with a control unit as shown that is connected, in particular, with the oscillation exciter 7 and the oscillation measuring unit 7′. Depending on the measured value of the measuring unit 7′, the oscillation exciter 7 is controlled to impel or excite the oscillation tube at the specified time.

The clamping points of the oscillator tube are always to be regarded as so-called nodal points of the oscillating system, but, however, filling the oscillator tube above these holding and clamping points plays no role in the oscillation and does not affect the measurement.

In the case of the “Y-oscillator” shown schematically in FIG. 3, the U-shaped bent tube 1 oscillates at right angles to the plane which is spanned by the two legs 2, 3 of the tube 1. In principle, oscillation modes are excited to oscillate the legs 2, 3 of the bent tube 9 against one another in this plane. In this way, certain resonant frequencies are available for the oscillator, wherein the oscillator and the tube 9 oscillate almost undamped.

In addition to apparatus constants, for example, such as the material and the dimensions of the oscillator, the density of the fluid to be investigated determines the specific frequencies at which the U-tube resonates. Thus, if the same tube is always used, in particular a glass tube or a metal tube, then the properties of the oscillator vary with the density of the fluid. The resonant frequencies are evaluated in terms of the excitation and pick-up of the oscillations and from the period, and from this the density of the filled fluid can be determined. The oscillator is adjusted or calibrated with fluids of known density, so that the measured values can be evaluated directly.

The fundamental frequency for the period P of this system is:
i)

$$P = 2 π \sqrt{\frac{( m + ρ V )}{R}} \qquad ( 1 )$$

resulting in the density through transformation:
ii)

$$ρ = {P}^{2} \frac{R}{4 {π}^{2} V} - \frac{m}{V} = A {P}^{2} - B \qquad ( 2 )$$

Where m is the oscillating mass, p is the density of the fluid, V is the volume of the tube, and R is a constant of the oscillator, in which, inter alia, the material and the waveform of the oscillator used are input.

The calibration constants A and B for the respective oscillator are determined by measurements with fluids of known density and stored in the evaluation unit of the oscillator.

In the case of frequency oscillators, therefore, changing the natural frequency of an oscillation mode and/or the period P is the same as filling the tube with fluid in order to infer the density of the medium.

In addition to laboratory oscillators with a large counterweight, double bend oscillators are also known which make the use of a large counterweight unnecessary by the use of two U-tubes which oscillate against one another with good accuracy, and are, therefore, also suitable for light and small handheld instruments.

In most applications, these hand density measuring devices are largely used to study specific aqueous solutions, for example, fermenting samples in the wine and beer industry, where the viscosity value of water hardly differs.

Alternatively, there are density measuring devices for special applications that take into account the viscosity value of the fluid in each particular application using calibration constants already available to correct the output of the density value of the frequency oscillator. Thus the viscosity can be corrected via the damping measurement. For special applications, however, viscosity correction of the density measurement by damping measurement is not necessary.

It is known that the viscosity of the medium to be examined has an influence on the results of the density measurement. Various correction methods are known for this viscosity correction, wherein they are based on the fact that the damping of the oscillator is operatively connected with the viscosity, and this relationship can be evaluated by measuring a characteristic of the damping parameter. This assumes that the oscillator tube is bubble-free, or the filled fluid shows no in homogeneities.

### SUMMARY OF THE INVENTION

The invention has the task of detecting or determining the degree of filling of the oscillator tube. The damping of the frequency oscillator is measured in addition to a natural frequency of the frequency oscillator and an evaluation is made with respect to filling in homogeneities in the oscillating tube. The damping, or a relevant parameter for the damping, is thus used for the detection of bubbles and/or in homogeneities in the filling.

The object is achieved by a method of the type mentioned. It is intended that by use of adjustment or calibration standards for the fluid to be tested, or for fluids possessing various viscosities, the relationship between the damping and/or oscillation amplitude of the frequency oscillator and the degree of filling of the oscillator tube is determined, and in the course of determining the degree of filling, a parameter that is relevant for the damping and/or oscillation amplitude of the frequency oscillator is measured, and the measured value is considered to be relevant and to be in a functional relationship to the degree of filling and can be used for evaluating or determining the degree of filling.

Other features which are considered as characteristic for the invention are set forth in the appended claims.

Although the invention is illustrated and described herein as embodied in a method of determining a fill level of an oscillator of an oscillator tube, and an oscillator tube it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of a frequency oscillator;

FIG. 2 is an illustration of a component of the frequency oscillator;

FIG. 3 is an illustration of a Y-oscillator;

FIG. 4 is a graph showing different amplitudes for one and a same oscillator once with and once without air bubbles in a measurement of water;

FIG. 5 is a graph showing a broadening of an amplitude spectrum in a known Bode diagram showing that a frequency shift also has to be greater in phase-shifted signal or in a case of phase-shifted excitation of the in homogeneously-filled oscillator;

FIG. 6 is a graph showing that the phase angles of excitation and pick-up do not match, where a resulting frequency f₂ is slightly different from the resonant frequency; and

FIG. 7 is an illustration of a frequency oscillator test assembly.

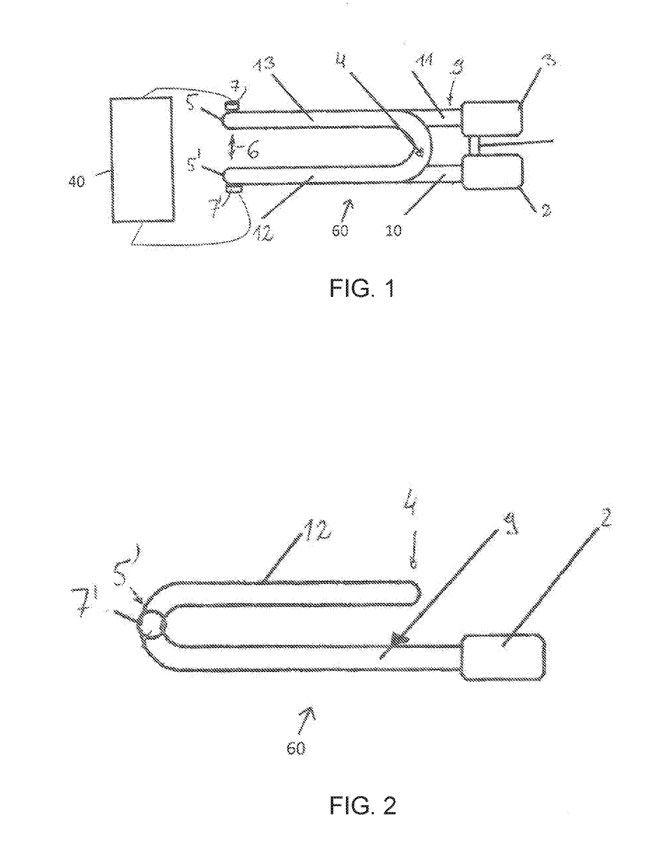

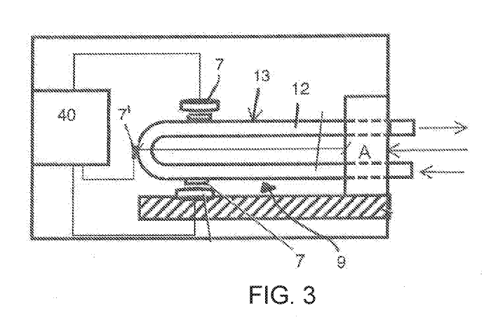

### DETAILED DESCRIPTION OF THE INVENTION

Surprisingly, it is found that accurate measurements can be obtained of the presence and extent of in homogeneities, particularly gas bubbles, in the fluid to be examined, even if the degree of filling of the two tube legs is different. In addition, a different distribution of in homogeneities and bubbles in the two tube legs does not influence the measurement results to an unacceptable extent. The expected influences of irregularly distributed in homogeneities do not play a significant role in the method according to the invention.

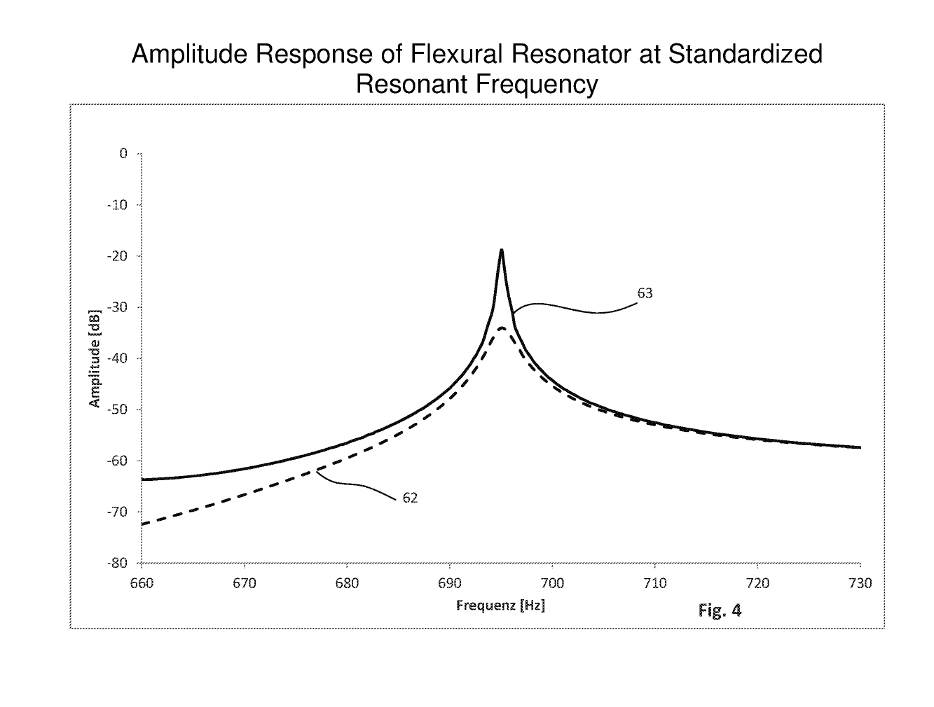

If one examines a frequency oscillator with respect to the amplitudes over a wider frequency spectrum around its resonant frequency (in this case: water, once with and once without gas bubbles in the fluid), we see a clearly different behavior, as shown in FIG. 4.

FIG. 4 shows the different amplitudes for one and the same oscillator once with and once without air bubbles in the measurement of water. One can clearly see here the influence of bubbles on the damping of the oscillator through the broader “blurred” amplitude peak in the frequency spectrum. The oscillator filled with in homogeneities shows stronger damping than the one without in homogeneities.

According to the invention, the oscillating U-tube is excited in its respective resonant frequency through two different phase angles for determination of the parameters relevant for the damping, the resonance frequency pertaining to the respective phase angles is determined, and the filling level thus inferred. The damping of such an oscillation structure can be easily determined, wherein the frequency oscillator is excited in its resonant frequency by two different phase angles, wherein the corresponding frequencies are measured and the damping is calculated. It is advantageous to tune or vary the phase angle between the excitation signal and the pick-up signal, which is generally 90°, for example, to a value of 45°. This is done by a control unit that is supplied with the pick-up signal and that sets or adjusts the excitation accordingly.

For this purpose, an additional element or phase shifter is introduced into the control unit circuit for the excitation and pick-up of the oscillator frequencies in order to shift or change the phase between the excitation and the pick-up.

In general, for the damping or for the quality of the oscillator: Q=f(f₁, f₂, φ₁, φ₂).

The oscillator is thus alternately or, for certain periods of time, excited with signals of different phase to that of the oscillation. For the oscillation in the modified phase angle, the excitation signal, with which the oscillator is excited to its resonance frequency, is offset in time with respect to the point in time of the excitation, i.e. phase shifted, so that a modified tuned resonant frequency results. In principle, the natural frequency of the oscillator remains the same, but the phase-shifted excitation is out of tune with the oscillator resulting in a slightly different frequency. This change becomes greater if the oscillator is not filled correctly.

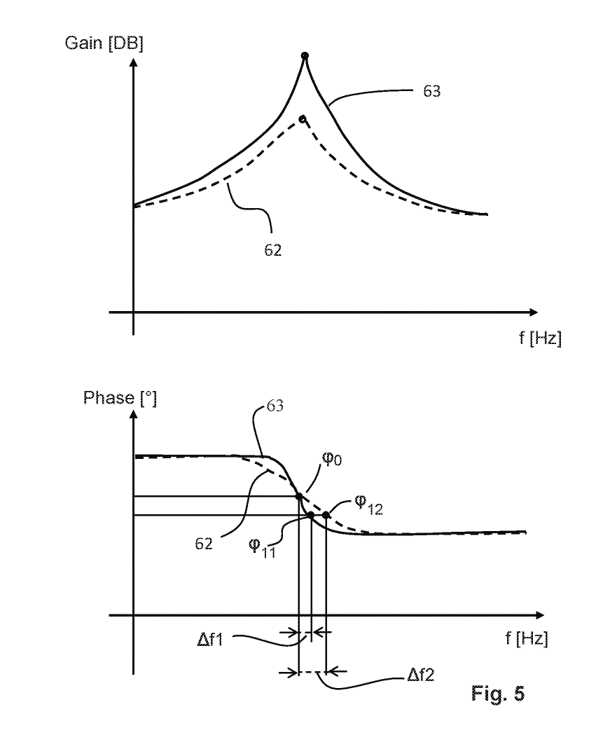

If one now examines the changed behavior of an in homogeneously-filled oscillator compared to a homogeneously-filled oscillator, one can see from the broadening of the amplitude spectrum in the known Bode diagram in FIG. 5 that the frequency shift also has to be greater in the phase-shifted signal or in the case of phase-shifted excitation of the in homogeneously-filled oscillator.

In the case of a difference Δf measured between the different phase angles in resonance and phase-shifted adjusting resonance frequencies f₁ and f₂, the difference for the homogeneously-filled transducer must be less than:

Δf(homogenous)<=Δf(inhomogenous)
where: Δf_{H}=f1(φ₁)_{H}−f2(φ₂)_{H}
and: Δf_{I}=f1(φ₁)_{I}−f2(φ₂)_{I.}

One can thus define a criterion for the maximum acceptable difference between the two frequencies to ensure the homogeneous filling of the oscillator and possibly a filling error warning and/or infer the degree of filling therefrom.

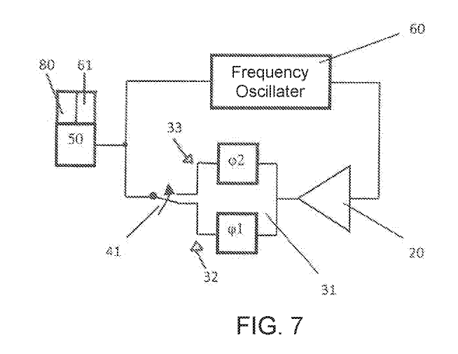

To this end, at least an element 32 changing the phase angle of the oscillator with respect to its excitation through the exciter amplifier is introduced into the circuit for excitation and signal pick-up of the oscillations (see FIG. 7). Switching back and forth between the “conventional” excitation signal φ1 and an excitation signal φ2 shifted by a specified phase angle, can be effected through an electronic switch 41.

Thus, the oscillator can be examined on excitation with approximately the same or a slightly different excitation frequency in two different phases. If the oscillator is excited in phase with the displacement amplitude, then the resonance frequency is f₁.

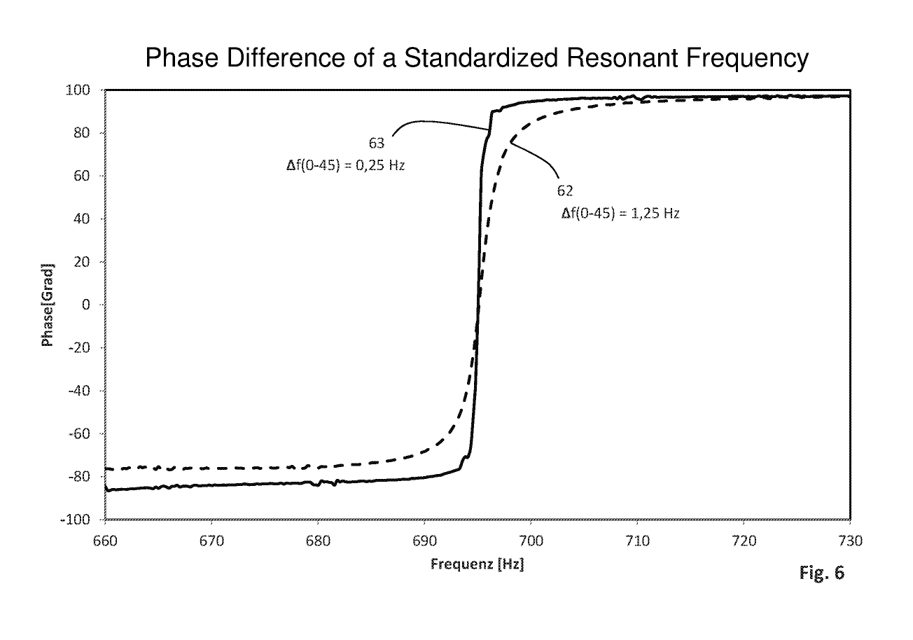

If the phase angles of the excitation and pick-up do not match, then the resulting frequency f₂ is slightly different from the resonant frequency as can be seen in FIG. 6

FIG. 7 shows a schematic diagram of an oscillating U arrangement according to the invention. The natural frequency of a frequency oscillator 60 or oscillator tube 9 filled with a medium is determined, wherein the frequency oscillator 60 is operated in a harmonic oscillator. A pick-up signal of the frequency oscillator 60 is amplified by an amplifier 20.

A phase shifter 31 shifts a phase of the signal so that a phase condition of the oscillation equation is satisfied in that this signal is provided in branch 32. In a parallel branch 33, the phase of the pick-up signal is also shifted by a constant value. This signal is available in branch 33.

By an electronic switch 41, it is now possible to switch between the two phase shifters or branches 32, 33. In principle, an additional phase shifter could be added to the circuit. The resulting resonant frequencies of the oscillator tube 9 are determined by frequency measurement with the measuring and control electronics 40 and the unit 50.

The excitation is integrated here circuit-wise in the phase shifter 31; in addition pick-up or measurement of the self-adjusting frequency can be affected in the unit 50.

The phase shifter 31 and the amplifier 20 in combination form the so-called excitation amplifier. With such an excitation amplifier, the oscillator 60 can be shifted into a state of resonant oscillation. The period or frequency of oscillation is measured by a frequency meter 50 and supplied to the evaluation unit 40 for density determination, wherein, by means of adjustment or calibration standards for the fluid to be examined or for fluids having various viscosities, the relationship between the damping and/or oscillation amplitude of the frequency oscillator 60 and the degree of filling of the oscillator tube 9 is stored in a memory unit 80.

The frequency oscillator 60 is operated with the excitation amplifier that excites the oscillator in one of its resonant natural frequencies. The frequency or period of the oscillator 60 is measured and can also be used in a known manner and with the aid of adjustment or calibration data to determine the density of the fluid medium to be examined.

An RC low-pass can serve as the phase shifter in the simplest case, or a more complex higher-order filter, or so-called dead time element that is generally a combination of a resistor and capacitor is used. With the amplifier and the oscillator, the phase shifter forms an oscillator which itself oscillates into resonance by noise or some other initial impulse.

In the event of change of the excitation or frequency shift, the amount of energy required to keep the amplitude constant can serve as a relevant parameter for the oscillation amplitude, because the presence of in-homogeneities or bubbles in the fluid decreases the amplitude and additional energy is necessary to maintain constant amplitude for the excitation.

An advantageous construction of the frequency oscillator requires that a comparison unit 61 be provided, which compares the resonant frequencies calculated for the two phase angles with one another or forms their difference, and, depending on the comparison or the size of the difference of the degree of filling of the oscillator tube 9, determines whether it is correct or incorrect.

1. A method for determining a degree of filling of a frequency oscillator having an oscillator tube with a fluid to be investigated, with respect to a density measurement of fluids with the oscillator tube, which comprises the steps of:
determining a relationship between a damping and/or oscillation amplitude of the frequency oscillator and the degree of filling of the oscillator tube by means of adjustment or calibration standards for the fluid to be examined, or for fluids possessing various viscosities; and
measuring a relevant parameter for the damping and/or oscillation amplitude of the frequency oscillator during a course of determining the degree of filling, and a measured value is considered as relevant and as being functionally related to the degree of filling, and can be used for evaluating or determining the degree of filling.

2. The method according to claim 1, wherein for determining the relevant parameter for the damping, exciting the frequency oscillator into its respective resonant frequency through two different phase angles, and the resonance frequency corresponding to a respective phase angle to infer the degree of filling determined from this.

3. The method according to claim 1, which further comprises comparing resonant frequencies ascertained at two phase angles with one another or their difference is formed, and depending on a comparison or a size, a difference of the degree of filling is determined and accordingly recognized as correct or incorrect.

4. The method according to claim 1, which further comprises determining resonance frequencies with the frequency oscillator filled with the fluid to be examined, wherein the frequency oscillator is operated as a harmonic oscillator.

5. The method according to claim 1, which further comprises using an amount of energy required for maintenance of an amplitude on measurement of the degree of filling as the relevant parameter for the oscillation amplitude.

6. A frequency oscillator, comprising:
an oscillator tube;
a unit for determining a degree of filling of said oscillator tube with a fluid to be examined related to density measurement of fluids, said unit having a memory unit for recording a relationship between a damping and/or oscillation amplitude of the frequency oscillator and the degree of filling of said oscillator tube determined by means of adjustment or calibration standards, namely for fluids possessing various viscosities; and
an evaluation unit for evaluating a parameter relevant for damping of the frequency oscillator and collected during determination of the degree of filling.

7. The frequency oscillator according to claim 6, wherein for determination of the parameter relevant for the damping, the frequency oscillator further comprising an oscillation exciter to excite said oscillating tube in a respective resonant frequency in two different phase angles, and that the resonant frequency associated with a respective phase angle is determined with said evaluation unit, and from this the damping is determined or an associated damping value calculated.

8. The frequency oscillator according to claim 6, further comprising a comparison unit for comparing two resonant frequencies associated with phase angles with one another or forms their difference, and as a function of a comparison or a size of the difference, the degree of filling of said oscillator tube is determined or recognized as correct or incorrect.

9. The frequency oscillator according to claim 6, wherein the frequency oscillator is configured as a harmonic oscillator, and thus resonance frequencies of the frequency oscillator filled with the fluid to be examined can be specified.

10. The frequency oscillator according to claim 6, further comprising a circuit having an oscillation exciter and an oscillation pick-up.

11. The frequency oscillator according to claim 10, wherein said circuit further having:
a control unit; and
a phase shifter switched on by or disposed in said control unit.
